(19) United States
(12) Patent Application Publication
(10) Pub. No.: US 2008/0248782 A1
(43) Pub. Date: Oct. 9, 2008

(54) Providing Devices With Command Functionality in Content Streams

(75) Inventors: Todd Stiers, Berkeley, CA (US); Jeremy de Bonet, North Andover, MA (US)

Correspondence Address: BEYER WEAVER LLP, P.O. BOX 70250, OAKLAND, CA, 94612-0250, US

(73) Assignee: MOBITV, INC., Emeryville, CA (US)

(21) Appl. No.: 11/694,825

(22) Filed: Mar. 30, 2007

Related U.S. Application Data
(60) Provisional application No. 60/790,334, filed on Apr. 7, 2006.
(60) Provisional application No. 60/790,260, filed on Apr. 7, 2006.
(60) Provisional application No. 60/790,268, filed on Apr. 7, 2006.

(51) Int. Cl. H04Q 7/20

(52) U.S. Cl. 455/412.2

(57) ABSTRACT

Mechanisms are provided for delivering command functionality such as out-of-band data to a mobile device in a media stream. A media stream may be divided into multiple portions. One or more portions are modified to include command functionality. The command functionality associated with the media stream is extracted at a mobile device. In particular instances, the command functionality provides notification of an event. The command functionality may be executed using one or more virtual machines associated with the mobile device.

### CROSS REFERENCE To PRIORITY APPLICATIONS

The present application claims priority to U.S. Provisional Patent Application No. 60/790,334, filed Apr. 7, 2006 entitled “System and Method for Implementing Out-Of-Band Functionality in Conjunction with Content Presentation” by Jeremy S. Bonet [MOBI1590]; U.S. Provisional Patent Application No. 60/790,260, filed Apr. 7, 2006 entitled “System and Method for Implementing Out-Of-Band Functionality in Conjunction with Content Presentation”, by Jeremy S. de Bonet [MOBI1600]; U.S. Provisional Patent Application No. 60/790,268, filed Apr. 7, 2006 entitled “System and Method for Communication Among Devices”, by Jeremy S. de Bonet [MOBI1620], the entireties of which are incorporated by reference for all purposes.

### TECHNICAL FIELD

The present disclosure relates to delivery of command functionality in content streams.

### DESCRIPTION OF RELATED ART

Providing command functionality along with data such as media streams to devices usually entails using a separate channel. For example, when a server sends a voice mail notification to a user, the server typically sends the notification on a channel separate from that used to transfer voice or multimedia data.

However, mechanisms for delivering command functionality and other out-of-band information in content streams are limited. Consequently, it is desirable to provide improved techniques for delivering command functionality in content streams.

### BRIEF DESCRIPTION OF THE DRAWINGS

The disclosure may best be understood by reference to the following description taken in conjunction with the accompanying drawings, which illustrate particular embodiments.

FIG. 1 illustrates an exemplary system for use with embodiments of the present invention.

FIG. 2 illustrates a technique for incorporating command functionality.

FIG. 3 illustrates data conversion and encapsulation.

FIG. 4 illustrates data reception and processing.

FIG. 5 illustrates a set of commands for a portion of data.

FIG. 6 illustrates an augmented set of commands for a portion of data.

FIG. 7 illustrates an architecture for implementing voting methodologies.

FIG. 8 illustrates an architecture for implementing email notification

FIG. 9 illustrates an architecture for implementing proximity notification methodology.

FIGS. 10 and 11 illustrates an architecture for implementing email notification.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular packet streams and networks. However, it should be noted that the techniques of the present invention apply to a variety of streams and networks. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

Mechanisms are provided for including command functionality in a media stream transmitted to a mobile device. A media stream may be divided into multiple portions. One or more portions are modified to include command functionality. The command functionality associated with the media stream is extracted at a mobile device. In particular instances, the command functionality provides notification of an event. The command functionality may be executed using one or more virtual machines associated with the mobile device.

### EXAMPLE EMBODIMENTS

Mobile devices are associated with numerous vendors, service providers, platforms, hardware configurations and widely varying capabilities. Because of the disparity between mobile devices, developers often can only write applications for relatively unified virtual machine layers running on the different mobile devices. The virtual machine layers present a relatively unified interface for application development. However, virtual machine layers such as a Java virtual machine or a Python virtual machine present a variety of drawbacks. For example, applications written for virtual machine layers will often run more slowly than applications written natively for specific devices. Although this is less of a concern in server and desktop environments, this is a significant concern in mobile device environments because of the limited processing and memory resources mobile devices typically provide.

Virtual machines also have a limited set of supported commands. In some instances, a command supported natively may not be supported by a virtual machine. Consequently, even if a server provide command functionality in a media stream and a mobile device has sufficient resources to run a virtual machine and a media application to decode the media stream, it does have the capability or support to process any command functionality included in the media stream.

It is often difficult to incorporate command functionality into a data stream. Consequently, command functionality is often provided out-of-band in a manner that separates a data stream and a command functionality stream. However, techniques of the present invention provide mechanisms for providing command functionality within a content stream.

According to particular embodiments, a video stream may be delivered to a device with command functionality related to the video content. In particular embodiments, it might be desirable to a user of a device to perform a voting activity in conjunction with a television program. For example, a producer of a television program might wish to include an opportunity to vote for a particular plot line or individual presented to a viewer during a particular television program.

It may also be desirable to deliver to a notification of events that have occurred. For example, if a user has received an email, if another user on a friend list is in close physical proximity to the user, or if a certain stock has reached a certain price, it may be useful to provide this information in a content stream.

One difficulty in presenting command functionality in a media stream simultaneously is how to coordinate the command functionality with the delivery and/or presentation of the in-band information. More specifically, it is difficult to determine when out-of-band data should be used or triggered and when out-of-band data should be made available. Furthermore, commands and procedures for out-of-band functionality may not even be supported by a virtual machine running on the mobile device.

Consequently, the techniques of the present invention provide mechanisms for including command functionality in one or more portions of a media stream. The command functionality may run on one or more virtual machines associated with a mobile device. According to particular embodiments, a data stream is separated into portions. One or more portions may be modified to include command functionality that a mobile device is configured to execute. The procedure may be executed in conjunction with a portion of content. In particular embodiments, multiple procedures are included, and some procedures may be run on a Java virtual machine while others run on a Python virtual machine using associated byte-code procedures.

A byte-code procedure is typically interpreted by a byte-code interpreter. The same byte-code can be executed on any processor on which the byte-code interpreter runs. The byte-code may be compiled to machine code (“native code”) for speed of execution but this usually requires significantly greater effort for each new target architecture than simply porting the interpreter.

According to particular embodiments, a procedure is associated with multiple commands. In particular embodiments, a procedure is resident on a mobile device and a data stream only need to deliver a call to the procedure. According to particular embodiments, the content itself does not have to be changed based on the out-of-band functionality it is desired to implement in conjunction with the content. The content may be encapsulated and augmented a single time and delivered to a wide variety of users. By delivering various procedures to the variety of users not only may different out-of-band functionality be implemented in conjunction with the same portion of content, but different out-of-band functionality may be implemented with respect to different users viewing the same portion and the out-of-band functionality may be individually tailored to a particular user.

By the same token, the systems and techniques of the present invention make it straightforward to add new out-of-band functionality which may be implemented in conjunction with one or more portions of content simply by implementing a new procedure for that out-of-band functionality and delivering this procedure in conjunction with an appropriate portion of content.

A format is a way of arranging, organizing, or representing data, usually using a defined standard such as MPEG or motion JPEG. For purposes of this application, formats will be understood to be distinct if characteristics of the represented data differ in any manner. Additionally the same standard at two different rates will be understood to mean two distinct formats. For example, high framerate motion JPEG would be a distinct format from low framerate motion JPEG. Furthermore, augmenting a defined standard with additional information will be understood to constitute a distinct format. For example, augmenting an MPEG representation of video data with closed captioning information would be a format distinct format from video data represented in the MPEG format alone. Compressed video data will also be understood as distinct from its uncompressed equivalent. For example, video data compressed with MPEG will be understood as distinct from identical uncompressed raw video data. Distinct formats may be created in an almost endless variety of ways, such as varying resolution, screen size, sampling rate, and the like.

Before describing embodiments of the present invention, it may be useful to describe exemplary architectures and data formats with which may be used by embodiments of the present invention. These data formats may facilitate the encapsulation, transmission, reception, decomposition and processing of heterogeneous sets of data. Data may be encoded in one of these data formats, and sent to a recipient, which decodes the data format and renders the data. These data formats may consist of the concatenation of a set of commands, each of these commands in turn composed of a tag, length and a payload. Furthermore, these data formats may provide a compact way to deliver information which allows the rendering of video, images, caption audio as well as user interaction functionality, while simultaneously reducing the computational complexity required of the recipient to decode the data format and render the varying types of data. These data formats may be ideally suited for distributing data in a client-server architecture where the encoding server is powerful relative to the many clients.

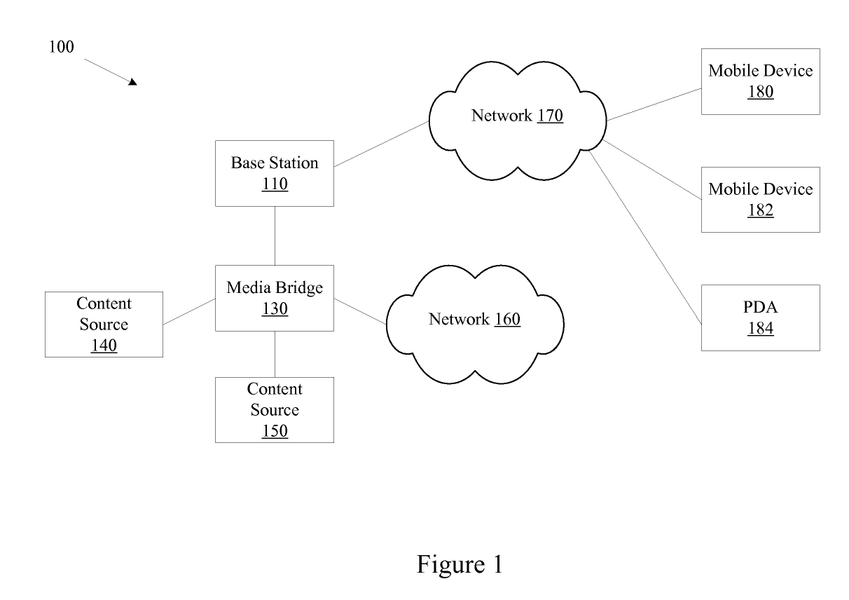

FIG. 1 illustrates one example of a communications system for use with embodiments of the present invention. System 100 includes a media bridge 130 for interfacing between different types of content systems 140, 150, 160 and one or more wireless (or potentially wireline) communication networks 170. Content systems 140, 150, 160 may be broadcast media such as television or radio, other audio or video data, such as a video feed from a DVD player, or the Internet.

Wireless communication network 170 is in turn composed of base station 110 that is configured to communicate with mobile devices (devices) 180, 182, 184. Mobile devices 180, 182, 184 may, for example, be cellular telephones, laptop computers, personal information managers (PIMs or PDA), or the like that are configured for wireless communication. These devices 180, 182, 184 may be running software designed for use with embodiments of the present invention. It should be noted that these devices 180, 182, 184 need not actually be “mobile,” but may simply communicate with base station 110 via a wireline or wireless link. Base station 110 transmits data to mobile devices 180, 182, 184 via corresponding forward link (FL) channels, while mobile devices 180, 182, 184 transmit data to base station 110 via corresponding reverse link (RL) channels.

Users of mobile devices 180, 182, 184 may wish to have content from content sources 140, 150, 160 delivered to them. This may be problematic, however, as delivery of much of this content typically requires large amounts of data to be delivered over a high-reliability high-bandwidth connection. Additionally, even if wireless network 170 is such a high-bandwidth network, mobile devices 180, 182, 184 may experience temporary periods of low-bandwidth connection to base station 110, or may be incapable of handling the complexity of such content. Media bridge 130 alleviates these problems by delivering tailored content from content source 140, 150, 160 to each individual mobile device 180, 182, 184.

Media bridge 130 may employ embodiments of the present invention to encapsulate content from content sources 140, 150, 160 for delivery to mobile devices 180, 182, 184 in a data format which is compact, and simplifies the tasks of decoding and rendering the data format performed by mobile devices 180, 182, 184. Streaming content from a content source 140, 150, 160 is fed into media bridge 130, at which point media bridge 130 may capture and digitize the incoming content if the data is not already in a digital format. This digitized data may be divided up into serialized portions and converted to a wide variety of formats. This data can then be encapsulated in portions (i.e. a finite set of data) with a certain data format and a particular series of portions may be sent to base station 110 for delivery to mobile device 180, 182, 184 depending on criteria associated with that particular device 180, 182, 184. It should be noted that the mobile devices 180, 182, 184 and system components in this figure are exemplary and other systems may include other types and other combinations of devices.

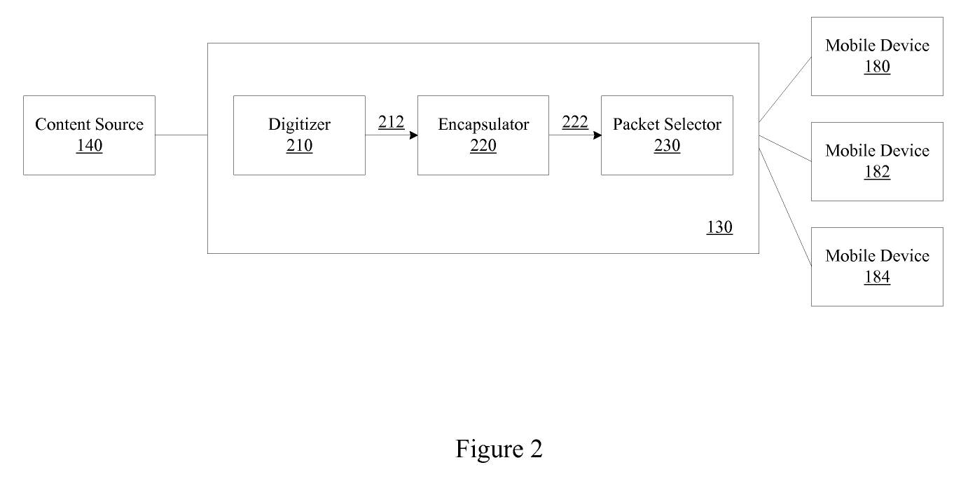

Embodiments of the steps involved in the distribution of data by media bridge 130 are depicted in more detail in FIG. 2. Content coming from media source 140 which is to be delivered to a device 180 may be in an analog format. This analog content, such as a television signal, radio broadcasts or video game data, may be captured using automatic or manual capture techniques, and converted to a digital signal (STEP 210). One of ordinary skill in the art will understand the many and varied ways to accomplish this capture and analog to digital conversion (STEP 210). In one embodiment, raw TV signal 140 may be connected to a TV tuner capture card, which in turn captures incoming analog TV signal 140. This analog signal 140 may be converted to a digital signal via the use of a standard analog to digital converter of the type that are well known in the art.

The resulting digital data 212 may be converted to a variety of formats and encapsulated in portions (STEP 220) in order to facilitate delivery of data 212 to device 180. Portions of this data 222 may then be selected for delivery (STEP 230) to device 180 based upon a set of criteria.

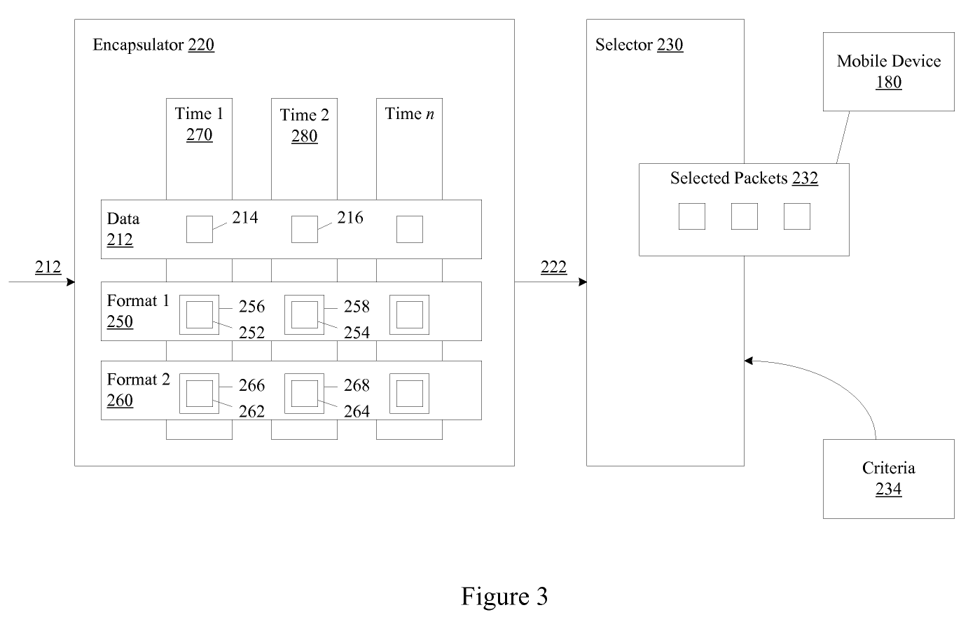

Moving now to FIG. 3, embodiments of the process for encapsulating data (STEP 220) are depicted in greater detail. Encapsulation process (STEP 220) may in turn include separating original data 212 into portions 214, 216 and converting those portions 214, 216 into a variety of different formats 250, 260. The resulting portions 252, 254, 262, 264 of data in different formats 250, 260 cover time periods 270, 280 corresponding to portions 214, 216 of original data 212. In other words, a portion 252 of data in one format 250 covers the same time period (quanta) 270 of original data 212 as corresponding portion 262 in another format 260.

To elucidate more clearly, if incoming original data 212 is digitized video data, original data 212 may be divided into portions 214, 216 which cover the first 20 seconds of the video represented by original data 212, with one portion 214 representing the first 10 seconds (time period one 270) and another portion 216 representing the second 10 seconds (time period two 280). Portions 214, 216 may then be converted to two different formats 250, 260. The resulting data portions 252, 262 corresponding to original portion 214 represent the same first 10 seconds (time period one 270) of original data 212, albeit in two different formats 250, 260. Similarly, data portions 254, 264 corresponding to original data portion 216 represent the second 10 seconds (time period 2 280) of original data 212 in two different formats 250, 260.

Additionally, during this conversion process each portion 252, 254, 262, 264 of the data may be augmented. For example, information regarding closed captioning may be added to a portion of video data represented in the MPEG format, billing information may be added to a portion of a web page represented in HTML, or Java content may be added to a portion of the data to provide interactive controls to users of mobile device 180. These portions 252, 254, 262, 264 of data may also be optimized for delivery to a device 180 through the use of compression algorithms and the like. In one embodiment, portions 252, 254, 262, 264 of the data may also be augmented with one or more additional commands intended to call a procedure resident on a device which receives portions 252, 254, 262, 264 (explained in more detail below).

After original data 212 is separated into portions 214, 216 and converted into different formats 250, 260, the resulting data portions 252, 254, 262, 264 may then be encapsulated in packets 256, 258, 266, 268 for delivery to device 180. Typical file formats for the encapsulation of data portions 252, 254, 262, 264 in packets 256, 258, 266, 268 may include layers dedicated to transmission protocols, application protocols, payload formats, and content formats.

In one embodiment, portions of data 252, 254, 262, 264 include a data format which allows the efficient encapsulation, transmission, reception, and decomposition of heterogeneous data. A portion 252, 254, 262, 264 may contain commands which have identical easy to decode structures, and which may be evaluated and executed in the order in which they are encoded, greatly simplifying the evaluation and execution of the commands, and rendering of the data, contained within a portion 252, 254, 262, 264.

More specifically, during encapsulation (STEP 220), each portion of data 252, 254, 262, 264 is converted to a set of commands, which when executed in a certain order are operable to instruct a decoding or rendering device to present the respective portion of data 252, 254, 262, 264. This set of commands can then be concatenated to form portions 252, 254, 262, 264 for delivery to device 180. All commands may have the same structure, and the order of command evaluation or execution may be determined by the order of the commands (and possibly the side effects of the evaluation). Each command may in turn be composed of a tag or command identifier, a length indicator and a data payload.

For example, the Bakus-Naur Form (BNF) of one embodiment of this type of data format is:

encapsulation := <command>*
command := <tag><length><payload>
tag := <byte>
length := [0-9]{12} (an integer in %012d format)
payload := <bytes>{<length>}

In this embodiment, a command identifier or tag is a character with an associated or mnemonic relationship to the functionality of the command. Using the example above, the command identifier is a single byte character:tag:=<byte>. In other embodiments, command identifiers can also be: multiple bytes, partial bytes (fewer than 8 bits) or strings.

Continuing with the above embodiment, a payload length indicator (length) is represented as a fixed length, ASCII encoded, zero prefix number. Using the example above, the payload length is twelve digits:length:=[0-9]{12} (an integer in %012d format). For example, a number of 000000002500 would indicate a payload which is 2500 bytes.

It will be apparent to those of skill in the art that payload length could also be specified using many numbering schemas, including: fixed length ASCII representation in decimal (base 10); fixed length ASCII representation in hexadecimal (base 16); fixed length ASCII representation in some other base; variable length ASCII representation, where a fixed length number is specified which specifies the length of payload representation (for example: if the length-length is identified with 1 ASCII digit, 217 would specify a payload length of 17, and 3568 would specify a payload length of 568, as in the fixed length case, this can be done using any base); fixed length binary representation, in either little-endian or big-endian order (this is how numbers are typically stored in a computer when human readability is not required) or variable length binary representation, where the first byte (or fixed number of bytes, or bits) establishes how many of the following bytes (or bits) encode the payload length.

Returning to the above embodiment, a data payload (payload) is composed of a series of bytes whose length is indicated by the payload length indicator. Using the above example, the data payload is:payload:=<bytes>{<length>}.

An example may be useful in explaining this specific embodiment in more detail. Suppose a portion of data 252, 254, 262, 264 is represented by the following XML code:

<image src=“image0.jpg” />
<text>this is a caption 0</text>
<display />
<pause duration=1000/>
<image src=“image1.jpg” />
<display />
<pause duration=3000/>
<text>this is a caption 1</text>
<display />
<pause duration=4000/>
<image src=“image2.jpg” />
<text>this is a caption 2</text>
<display />
<pause duration=6000/>

It will be apparent that many variations on the above data format may be used as well. For example, in some embodiments the order of the command identifier and payload length may be in different orders, while in other embodiments the length of the command identifier could be included in the payload length.

Referring again to FIG. 3, after the incoming data is digitized (STEP 210), converted to a variety of formats and encapsulated in portions (STEP 220), packets 232 may be selected for delivery to a device 180 based on a set of criteria 234 (STEP 230). A user of device 180 may wish to obtain certain content. That content may be digitized (STEP 210) and encapsulated into portions of varying formats and these portions in turn, encapsulated in packets for delivery (STEP 220). Packets 232 may then be selected to be delivered to device 180 based on a set of criteria (STEP 230).

This criteria 234 may include user influenced factors such as bandwidth availability, the type of device 180, time of day, user account information or subscription service, and user age and preferences. Criteria 234 may also include external factors such as the network configuration, the CPU and databases being used in the system, and channel availability. Criteria 234 may be updated dynamically as packets 232 are selected to be delivered to device 180. Additionally, criteria 234 may be obtained directly from device 180, either via querying device 180 directly, or device 180 updating criteria 234 dynamically at the behest of a user.

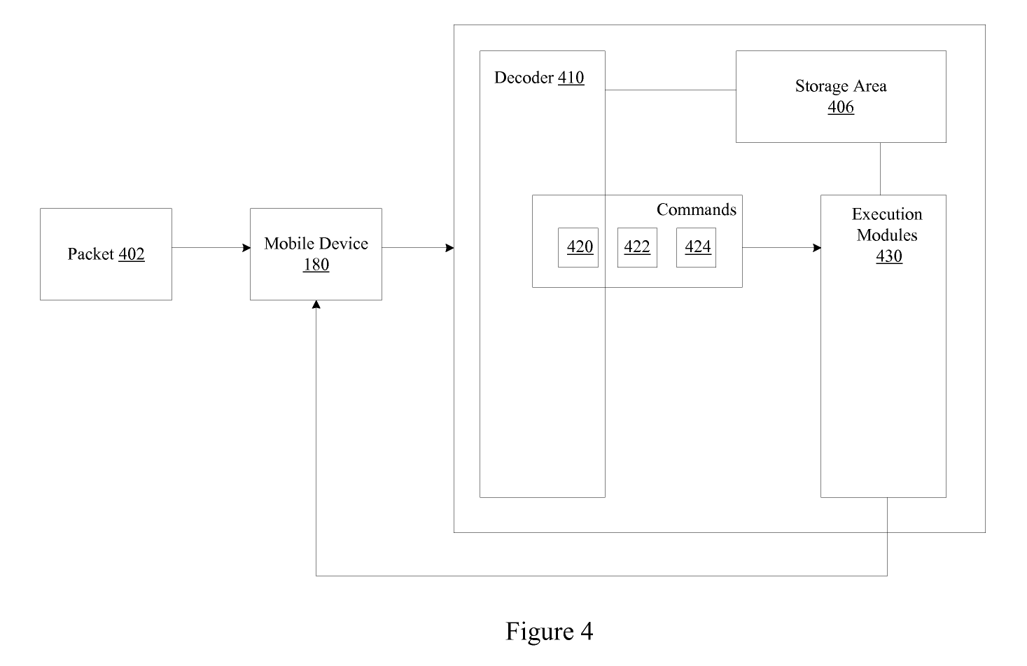

Based on criteria 234, packets 232 may be selected for delivery to device 180 (STEP 230). Turning now to FIG. 4, an embodiment of the reception and processing of packets 232 by a mobile device is depicted. Mobile device 180 may receive packet 402 from media bridge 130 via base station 110. Decoder 410, on mobile device 180, may then extract each command 420, 422, 424 encapsulated in packet 402. In one embodiment, packet 402 may contain data in the format described above where each command 420, 422, 424 is composed of a single character command identifier, followed by a 12 digit (zero-prefixed) length, followed by a data payload which is of this length. Decoder 410 identifies an encapsulated command 420, 422, 424 by identifying a tag and a corresponding payload using the length element of each command 420, 422, 424.

For each command 420, 422, 424, decoder 410 may perform a corresponding action. In one embodiment, decoder may identify the type of command 420, 422, 424 using the associated tag. This command may then be passed to one of execution modules 430 based on the type of command 420, 422, 424.

It will be apparent that because embodiments of the data format discussed allow commands within a portion to be executed in the order encountered, a command may decoded and passed to an execution module for execution. During execution of this first command a second command may be decoded. This allows a portion to be decoded and rendered more efficiently. For example, command 424 may be decoded and passed to execution modules 430 for execution. Simultaneously with the execution of command 424 decoder 430 may be in the process of decoding another command 422.

In one particular embodiment, decoder 410 on mobile device 180 is implemented as a finite state machine which evaluates commands 420, 424, 426 based on the order in which commands 420, 422, 426 are encapsulated in the portion contained in packet 402. For each command 420, 422, 424, decoder 410 may identify the type of command 420, 422, 424 using the associated command tag. If the decoder is able to execute command 420, 422, 424 it may pass command 420, 422, 424 to one of a set of execution modules 430, where command 420, 422, 424 may be executed and the state of mobile device 180 altered accordingly. When decoder 410 encounters a command 420, 422, 424 which it does not know how to evaluate decoder 410 may skip the remaining portion of this command using the length portion of the command to determine the start of the next command. By skipping unknown commands new command types may be added to a data format while still allowing legacy devices to process the data format.

Device 180 may also have a location for data storage 406, such as a random access memory (RAM) or the like. In one embodiment, the lexicon of commands which may be used in conjunction with portions may include a store command. More specifically, a portion contained in packet 402 may contain one or more commands which may store a name or variable and a corresponding procedure or value in storage 406. Storage 406 may include a hash table for the variables and their associated procedures or value.

In one embodiment, this procedure itself is included of commands which are a set, superset or subset of commands in the lexicon of commands which may be decoded or rendered by decoder 410. In one particular embodiment, the command to store a procedure to storage 406 may be an assignment or ‘a’ command. The commands comprising procedures stored in storage 406 may later be rendered by decoder 410, for example when called by another command. As can be seen then, a variety of procedures and values can be stored in storage 406, with each of these procedures or values associated with a variable or name.

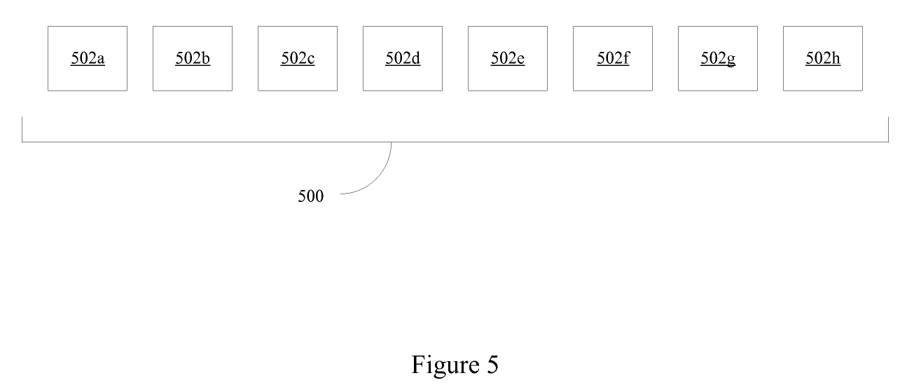

As previously discussed then, each portion being delivered by media bridge 130 may, in one embodiment, include a set of commands. FIG. 5 depicts a representation of an example set 500 of commands 502 operable, when rendered, to display motion JPEG format audio/video data. The set 500 of commands 502 includes an “A” command 502a, an “I” command 502b, a “D” command 502c, a “P” command 502d, an “I” command 502e, a “D” command 502f, a “P” command 502g and an “I”command 502h. That set 500 of commands 502 may be audio, image, display, pause, image, display, pause and image commands, respectively, and may be operable, when rendered by decoder 410, to play audio for some amount of time and simultaneously display an image and pause and display an image and pause etc, resulting in the display or rendering of motion JPEG format audio/video data.

As in FIG. 5 the main stream (in-band) data to be rendered by decoder 410 includes a set 500 of commands 502, the in-band data included by commands 502 may be augmented with out-of-band data by directly inserting other commands comprising this out-of-band data into the set 500 of commands 502 which includes a particular piece of in-band content. However, this solution is less than ideal, as these out-of-band procedures may be rather large and it may be desired to augment a particular piece of content differently depending on a wide variety of criteria or circumstances. For example, it may be desirable to augment in-band content with a weather alert if a person is in a certain locale; the ability to vote if a certain piece of in-band content is being viewed at a certain time; the ability to purchase a particular good or service etc. Consequently, it is desirable to have a way in which in-band content may be augmented by other data and/or data which allows a user of a device to perform some action (collectively referred to as out-of-band data) such that the out-of-band data may be rendered and/or used in conjunction with the in-band content and the functionality, or type, of out-of-band data may be altered based on various criteria, conditions or circumstances.

Exemplary architectures for delivering out-of-band data to a user in conjunction with in-band data to be delivered to the user are now described. These architectures may, when encapsulating portions of data, augment the set of commands comprising a portion of data or content with one or more additional commands operable to render or call a procedure resident on a device to which the portion of data may be delivered. The functionality of that procedure can then be altered on an individual device based on one or more conditions or circumstances. This procedure may then be retrieved and rendered in conjunction with the data stream. This procedure may be changed, altered or replaced based on conditions or circumstances, for example events in the data stream, the external world or a wide variety of other criteria. Additionally, during the encapsulation of the data stream commands to retrieve and execute a procedure may be inserted into the set of commands comprising the data stream at various intervals. When this data stream is delivered to a device 180, 182, 184 appropriate procedures may then be delivered to the device 180, 182, 184 at appropriate times.

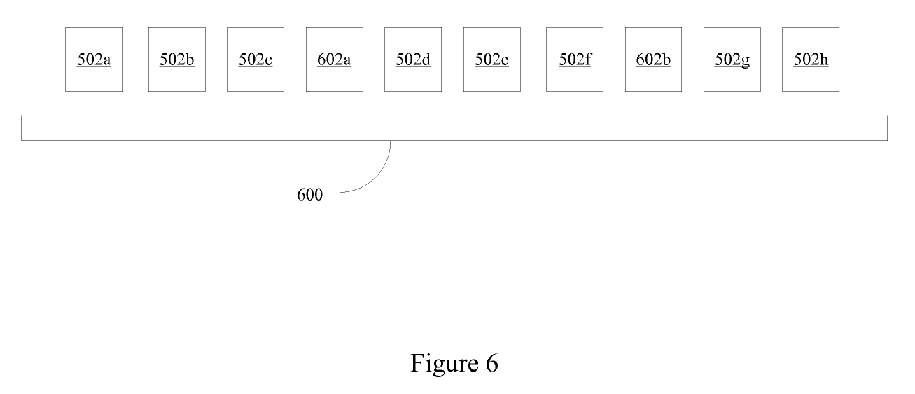

In one embodiment, during encapsulation of data into portions by media bridge 130 a set of commands comprising a portion of data or content may be augmented to include one or more commands which serve to render a procedure which may be stored on the device 180, 182, 184 receiving the portion. Moving to FIG. 6, a representation of the example set 500 of commands 502 of FIG. 5 augmented with just such a command is depicted. Here the set 600 of commands 502, 602 may be “A” command 502a, “I” command 502b, “D” command 502c, “r” (interframe) command 602a, “P” command 502d, “I” command 502e, “D” command 502f, “r” (interframe) command 602b, “P” command 502g and “I” command 502h.

When rendered by decoder 410, “r” command 602 may cause a procedure called “interframe” to be retrieved from storage area 406 on device 180 and this procedure rendered or executed by decoder 410, if it exists in storage area 406. If a procedure named “interframe” does not exist in storage area 406, the next command in the set 600 of commands 502, 602 is rendered by decoder 410. Thus, by changing the procedure associated with the name “interframe” which is stored in storage area 406 of device 180 different functionality can be associated with different points in a data stream, or, by not having a procedure named “interframe” stored on the device, the data stream can be rendered substantially identically to how it would be rendered without the inclusion of the “r” commands 602. According to particular embodiments, “r” command 602 may run in a first address space associated with a first virtual machine. Other commands may run in a logically distinct second address space associated with a second virtual machine. Different commands supported by different virtual machines can be included in a single content stream. In some instances, the byte codes are included in one or more portions. In other examples, the byte codes are included in the content stream itself.

Continuing with example depicted in FIG. 6, device 180 receiving and rendering this set 600 or augmented portion of commands 502, 602 may do the following: play audio, display image, render the procedure named “interframe” stored in the device if it exists, pause, image, display, render the procedure named “interframe” stored in the device if it exists, pause, image.

It will be apparent that the procedure named “interframe” may have wide and varied functionality. It will also be apparent that these procedure calls can be placed in a set of commands comprising a data stream at almost any interval whatsoever and that portions of data may be augmented with commands intended to call other procedures as well.

For example, suppose it is desired to put up a new GUI at certain intervals. This may be computationally expensive, so it may be desired to do this only at the beginning of each portion of a main data stream. In one embodiment, to accomplish this, a recall (“r”) command to a procedure called “portionstart” may be inserted by media bridge 130 at the beginning of a set of commands for each portion of the a data stream. In this case, as described above, when rendered, “r” command may cause a procedure called “portionstart” to be retrieved from storage area 406 on device 180 and this procedure rendered or executed, if it exists. By changing the procedure named “portionstart” on device 180 rendering the main data stream different functionality can be obtained at the beginning of each portion of the main data stream, including rendering a GUI.

Thus, using the example depicted in FIG. 6, after further augmenting the set 600 of commands 502, 602, the set of commands may resemble this: an “r” (portionstart) command, an “A” command, an “I” command, a “D” command, an “r” (interframe) command, a “P” command, an “I” command, a “D” command, an “r” (interframe) command, a “P” command and an “I” command. So a device receiving this set of commands may render the procedure named “portionstart” if it exists on the device, audio, image, display, render the procedure named “interframe” stored in the device if it exists, pause, image, display, render the procedure named “interframe” stored in the device if it exists, pause, image.

In many embodiments, these recall (“r”) commands are very small, for example they might just be pointers to another function. As a result the size of a portion does not increase substantially if the set of commands comprising the portion of data is augmented with these recall (“r”) commands. Another advantage to this scheme of augmenting data is that the various procedures called could be generated or delivered, for example, by media bridge 130 delivering data to a device.

For example, if a person is watching a talent competition live, it may be desired to activate procedures that allow a viewer to vote on one of the competitors in the talent competition. However, if a person is viewing a re-run of the same program it may not be desirable to activate these procedures. Thus, it may be desirable to have a process which delivers appropriate out-of-band data to a device in conjunction with the main data stream being delivered to the device.

In one embodiment, this may be accomplished by assigning the procedures called by the commands used to augment a main data stream (e.g. “r” (portionstart), “r” (interframe)) according to certain criteria or conditions. For example, media bridge 130, which is delivering the augmented main data stream to a device, may deliver a command to a device in conjunction with an augmented portion of a main data stream. This command may include a procedure and be operable to assign the name “interframe” to the procedure. Similarly, another procedure may be delivered and assigned the name “portionstart”. When the device 180 next renders a portion of the augmented main data stream the procedures named “interframe” and “portionstart” will be rendered in conjunction with the main data stream.

As discussed above, one particularly useful application of the systems and techniques of the present invention is to implement a voting mechanism which may be used in conjunction with various types of content. For example, imagine a person is watching a debate and the person presses one when the person likes what the Republican says and the person presses two when the person likes what the Democrat says. When the debate (main stream) is encapsulated into portions it is augmented with these recalls to interframe, and a voting module might define the interframe procedure to be, if one is pressed, send a vote for the Republican and if two is pressed, send a vote for the Democrat.

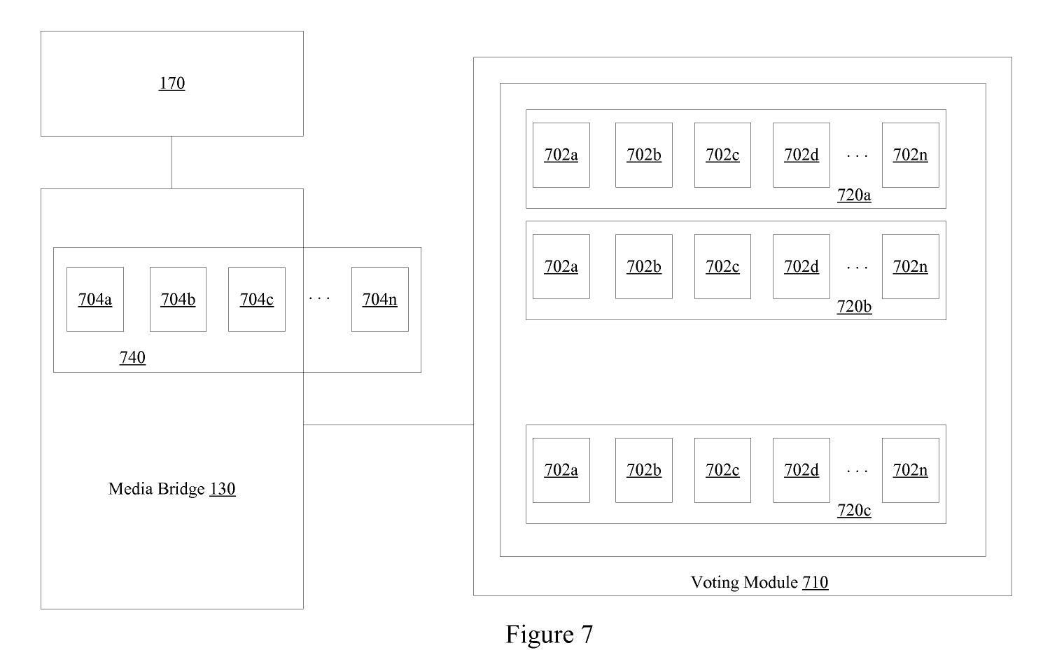

Turning to FIG. 7, one embodiment of an architecture for implementing voting methodologies using the systems and techniques of the present invention is depicted. Voting module 710 may be coupled to media bridge 130 or be executing on or in conjunction with media bridge 130. Voting module 710 may, in turn, include meta-data module 712 or any other type of module. Voting module 710 may utilize information on a main data stream being delivered to a device by media bridge 130 and other data to provide out-of-band data in conjunction with the main data stream.

In one embodiment, meta-data module 712 may contain sets 720 of XML files 702 corresponding to particular pieces of content, each of these XML files 702 may in turn correspond to a specific portion of each piece of content, and may include information on out-of-band data which may be used in conjunction with that portion of the content. For example, set 720a of XML files 702 may correspond to content 740. Similarly, XML file 702a may include information on out-of-band data corresponding to portion 704a of content 740 while XML file 702b may include information on out-of-band data corresponding to portion of content 704d. Note that some portions 704 of content 740 may have more than one corresponding XML file 702 while other portions 704 may have no corresponding XML files 702. Voting module 710 may also contain other information, criteria or conditions, such as real-time data pertaining to locations, received alerts, type of device to which content is being delivered etc.

During or before delivery of a portion of content 704 to a device 180, 182, 184 voting module 710 may ascertain if there is an XML file 702 corresponding to that portion of content 704 in the set 720 of XML files 702 corresponding to that content 740. If so, voting module 710 may use the information provided by the corresponding XML file 702 and/or other information, criteria or conditions to determine if out-of-band content should be delivered to the device 180, 182, 184 along with portion of content 704 and, if so, what the out-of-band content should be. In some cases, it may be determined that a user to which content 740 is being delivered should have the opportunity to vote on certain options. To this end, voting module 710 may select an appropriate procedure to allow a user of a device to vote on these options. Data, including a selected procedure may then be communicated to media bridge 130.

Media bridge 130 may receive data from voting module 710 and based on the data received deliver certain data to the device 180, 182, 184 along with the portion 704 of content. For example, media bridge 130 may receive a procedure from voting module 710 which is operable to allow a user to vote on a set of options. Media bridge 130 may deliver the procedure to device 180, 182, 184 in conjunction with a command operable to assign the name “interframe” to this procedure. In one embodiment, media bridge 130 may deliver this procedure to the device by prepending it to the portion 704 of content to be delivered, appending it to the portion 704 of content to be delivered or delivering it separately from the portion 704 of content. Thus, when the device 180, 182, 184 renders the next portion 704 of data (which has been augmented with one or more “r” “interframe” commands as discussed above) this procedure (which has been assigned to the name “interframe”) may be executed and the user allowed to vote on a set of options in conjunction with the rendering of the portion 704 of content.

In one embodiment, this procedure may display a set of options to a user of a device and allow a user to select one of the options using an input mechanisms on the device.

Continuing with the above example, before or during delivery of the next portion 704 of content to a device voting module 710 may ascertain that there is no XML file 702 corresponding to that portion 704 of content 740 and inform media bridge 130 that no out-of-band data is to be made available during the next portion of content 704 which is to be delivered to the device. In this case, media bridge 130 may deliver to the device a command to eliminate the procedure named “interframe” from storage area 406 of the device. Thus, when the device renders the next portion of data (which includes one or more “r” “interframe” commands as depicted above) only the main stream of data will be rendered to a user.

Now suppose, before or during delivery of the next portion 704 of content to a device 180, 182, 184, voting module 710 determines that a user to which portion 704 of content 740 is being delivered should have the opportunity to vote on another set of options. To this end, voting module 710 selects an appropriate procedure to allow a user of a device 180, 182, 184 to vote on these options. Media bridge 130 may receive this procedure from voting module 710 and deliver the procedure to the device 180, 182, 184 in conjunction with a command operable to assign the name “interframe” to this procedure. Consequently, when the device 180, 182, 184 renders the next portion 704 of data (which has been augmented with one or more “r” “interframe” commands as discussed above) this new procedure (which has been assigned to the name “interframe”) may be executed and the user allowed to vote on another set of options in conjunction with the rendering of that portion 704 of content 740.

Note that portions 704 of content 740 did not have to change to execute different procedures (e.g. to vote on two distinct sets of options) or to do nothing at all. Because portions 704 of content 740 do not need to be altered, content 740 may only need to be encoded or augmented a single time while the functionality associated with portions of this content may be almost endlessly variable

It will be apparent that the methodology discussed above may be used to render or present a wide variety of out-of-band data in conjunction with a main stream of data (content), in fact basically almost any functionality which is desired to be used in conjunction with a main data stream may be implemented using the above methodologies. For example, suppose it is desired to have a alert when there is a weather warning in an area. Media bridge 130 may receive a notification that a particular weather alert procedure should be delivered to anyone located in Boston. Media bridge 130 may then deliver a command which assigns this weather alert procedure to the name “interframe to devices in the Boston area. Thus, during rendering of the next portion of an augmented main data stream this procedure will be executed and a weather alert displayed to these devices.

Another useful application of such methodologies and systems may be to provide personal notification of certain events to users such that these personal notifications may be given in conjunction with various types of content and presented using the same medium as is being used to deliver, access or render the content. For example, suppose a person is viewing or listening to content such as a television program or radio broadcast (i.e. a main stream) on a device or using a device for some other purpose, such as a phone call (i.e. a main stream). During this time period a user receives an email. It may be desirable to then immediately inform a user of the fact that he has received an email. To accomplish this, when the television program or radio broadcast (main stream) is encapsulated into portions it is augmented with a procedure calls (e.g. to interframe or another procedure name as discussed above), and a email module might define the called procedure such that the procedure notifies the user of the received email at the device.

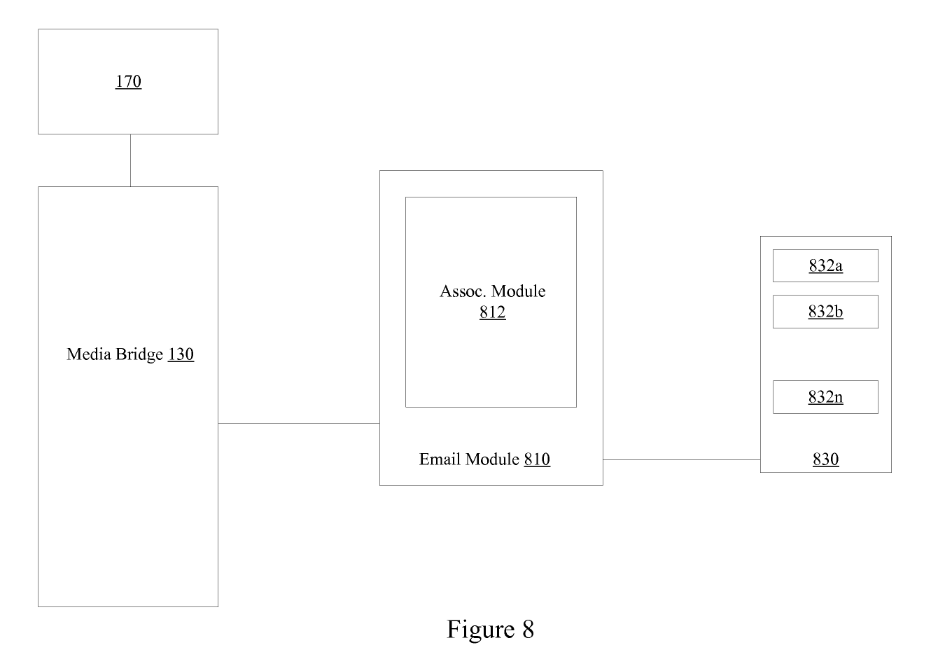

Turning to FIG. 8, one embodiment of an architecture for implementing email notification methodologies using the techniques and mechanisms of the present invention are depicted. Email module 810 may be coupled to media bridge 130, or be executing in conjunction with, media bridge 130. Additionally, email module 810 may have access to email system 830 comprising email inboxes 832. Email module 810 may, in turn, include association module 812. Email module 810 may utilize information on email inboxes 832 and/or other data to provide email notification in conjunction with the main data stream.

In one embodiment, association module 812 may contain associations between a particular email inbox 832 and a particular device 180, 182, 184. Email notification module 810 may also contain other information, criteria or conditions, such as real-time data pertaining to locations, received alerts, type of device to which content is being delivered etc.

During or before delivery of content (or a portion thereof) to a device 180, 182, 184 email module 810 may ascertain if new mail is present in inbox 832 corresponding to the device 180, 182, 184 to which content is to be delivered or is being delivered. If new mail is present in the corresponding inbox 832, email module 810 may determine that a user at the device 180, 182, 184 should be notified that he has a new email message. Additionally, email module 810, may select, assemble or tailor a procedure suitable for informing a user that he has an email message.

Media bridge 130 may receive data from email module 810 and based on the data received deliver certain data to a device 180, 182, 184 either in a standalone communication or along with a portion of content. For example, media bridge 130 may receive a procedure from email module 810 which is operable to place a graphic on a device 180, 182, 184 indicating that a user has an email. Media bridge 130 may deliver the procedure to the particular device 180, 182, 184 in conjunction with a command operable to assign the name “interframe” to this procedure. In one embodiment, media bridge 130 may deliver this procedure to the device by prepending it to a portion of content to be delivered to the device 180, 182, 184, appending it to a portion of content to be delivered to the device 180, 182, 184 or delivering it separately from a portion of content. Thus, when the device 180, 182, 184 renders the next portion of content (which has been augmented with one or more “r” “interframe” commands as discussed above) this procedure (which has been assigned to the name “interframe”) may be executed and the user provided with a notification he has email in conjunction with the rendering of the portion of content.

In one embodiment, this procedure may place a graphic on the display of the device 180, 182, 184. In another embodiment, the procedure may inform the user of the device 180, 182, 184 that he has email using audio information. As mentioned above, email module 810 may tailor this procedure specifically based on criteria, conditions, or other data associated with the device to which the procedure is to be delivered. For example, email module 810 may ascertain that a newly present email in an inbox 832 is from a certain address or sender and tailor a procedure for a device 180, 182, 184 associated with that inbox 832 such that it displays a graphic in conjunction with the name of the sender of the email. Using one embodiment of a command syntax and command functionality that may be employed with the systems and techniques of the present invention, pseudocode for an exemplary procedure for informing a user that the user has email may be as follows:

| a(interframe, /*assign the name interframe */ | |
|---|---|
| b(you've_got_mail_graphic) /*place graphic */ | |
| a(interframe, )) | /* clear assignment of interframe */ |

It will be apparent that the systems and techniques of the present invention can be used to deliver almost any type of out-of-band data regarding almost any type of event and may serve to inform a user of these events in a wide variety of ways. In another example, a person is viewing or listening to content such as a television program or radio broadcast (i.e. a main stream) on a device or using a device for some other purpose, such as a phone call (i.e. a main stream). During this time a friend of the user comes in close physical proximity to the user. It may be desirable to then immediately inform a user of the fact that one of his friends is located close by. To accomplish this, when the television program or radio broadcast (main stream) is encapsulated into portions it is augmented with these recalls to interframe, and a friends module might define the interframe procedure such that the procedure notifies the user of the location of the friend at the device.

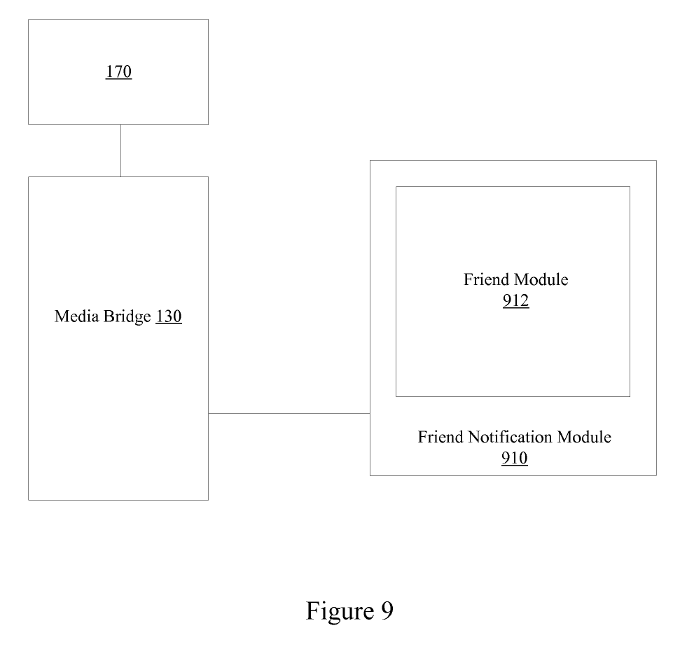

FIG. 9 depicts one embodiment of an architecture for implementing methodologies for notifying a user that a friend is within a certain proximity using the techniques and mechanisms of the present invention. Friend notification module 910 may be coupled to media bridge 130 or be executing in conjunction with media bridge 130. Additionally, friend notification module 910 may, in turn, include friend module 912. Friend notification module 910 may utilize friend module 912 and/or other data to provide a notification of a close (in the sense of physical proximity) friend in conjunction with the main data stream.

In one embodiment, friend module 912 may contain association between a particular device 180, 182, 184 and one or more other devices 180, 182, 184 whose ostensible users are considered “friends” of the device 180, 182, 184 (friend in this context can therefore be understood to mean a relationship or association between two devices 180, 182, 184). Friend notification module 910 may also contain other information, criteria or conditions, such as real-time data pertaining to locations, received alerts, type of device to which content is being delivered etc.

During or before delivery of content to a device 180, 182, 184 friend notification module 910 may ascertain the friends of the device 180, 182, 184 to which content is to be, or is being, delivered (in other words which devices 180, 182, 184 are associated with the device 180, 182, 184) using friend module 912. Friend notification module 910 may then ascertain if these “friends” of the device 180, 182, 184 to which content is to be, or is being, delivered are within a certain distance of one another. The location of both the device 180, 182, 184 to which content is to be, or is being, delivered and friends of this device 180, 182, 184 may be stored by friend notification module 910 and this location may originally be determined using methods known in the are or other methods such as those depicted in U.S. Provisional Patent Application No. 60/683,842, filed May 24, 2005 entitled “System and Method for Location Based Channel Restriction” by Jeremy S. De Bonet [MOBI1410], which is incorporated by reference herein in its entirety. If friends of the device 180, 182, 184 are located within this distance friend notification module 910 may determine that a user at the device 180, 182, 184 to which content is being delivered should be notified that he has a friend in close physical proximity. Additionally, friend notification module 910, may select, assemble or tailor a procedure suitable for informing a user of this fact.

Media bridge 130 may receive data from friend notification module 910 and based on the data received deliver certain data to the device 180, 182, 184 either in a standalone communication or along with a portion of content. For example, media bridge 130 may receive a procedure from friend notification module 910 which is operable to place a graphic on a device 180, 182, 184 indicating that a user has a friend that is close. Media bridge 130 may deliver the procedure to the particular device 180, 182, 184 in conjunction with a command operable to assign the name “interframe” to this procedure. In one embodiment, media bridge 130 may deliver this procedure to the device by prepending it to a portion of content to be delivered to the device 180, 182, 184, appending it to a portion of content to be delivered to the device 180, 182, 184 or delivering it separately from a portion of content. Thus, when the device 180, 182, 184 renders the next portion of content (which has been augmented with one or more “r” “interframe” commands as discussed above) this procedure (which has been assigned to the name “interframe”) may be executed and the user.

In one embodiment, this procedure may place a graphic on the display of the device 180, 182, 184 which informs the user he has a friend in close proximity. In another embodiment, the procedure may inform the user of the device 180, 182, 184 that he has a friend in close proximity using audio. As mentioned above, friend notification module 910 may tailor this procedure specifically based on criteria, conditions, or other data associated with the device to which the procedure is to be delivered. For example, friend notification module 910 may tailor a procedure for a device 180, 182, 184 such that it displays a name associated with the friend in close proximity.

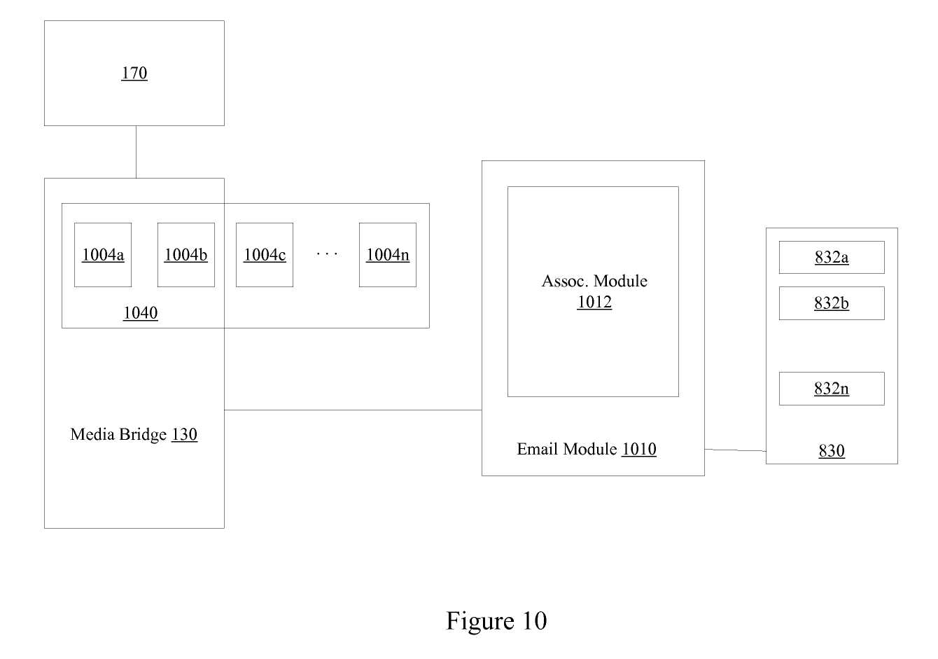

Though the above architectural arrangements may accomplish many tasks, the same or similar goals may also be accomplished by different arrangements, applications or embodiments of the techniques and mechanisms of the present invention. Turning to FIG. 10, another embodiment of an architecture for implementing email notification methodologies using the techniques and mechanisms of the present invention is depicted. Email module 1010 may be coupled to media bridge 130 or be executing in conjunction with media bridge 130. Additionally, email module 1010 may have access to email system 830 comprising email inboxes 832. Email module 1010 may, in turn, include association module 1012. Email module 1010 may utilize information on email inboxes 832 and/or other data to provide data on email notification in conjunction with the main data stream.

In one embodiment, association module 1012 may contain association between a particular email inbox 832 and a particular device 180, 182, 184. Email notification module 1010 may also contain other information, criteria or conditions, such as real-time data pertaining to locations, received alerts, type of device to which content is being delivered etc.

During or before delivery of content to a device 180, 182, 184 email module 1010 may ascertain if new mail is present in inbox 832 corresponding to the device 180, 182, 184 to which content is to be delivered or is being delivered. If new mail is present in the corresponding inbox 832 email module 1010 may determine that a user at the device 180, 182, 184 should be notified that he has a new email message.

Media bridge 130 may receive data from email notification module 1010 and based on the data received deliver certain data to a device 180, 182, 184 either in a standalone communication or along with a portion 1004 of content 1040. More specifically, in one embodiment media bridge may augment the set of commands which include the portion 1004 of content to be delivered to device 180, 182, 184 such that when portion 1004 of content 1040 is rendered be device 180, 182, 184 the part of content 1040 previously included by portion 1004 will have an email notification. For example, portion 1004 to be delivered to device 180, 182, 184 may include a set of commands operable, when rendered by device 180, 182, 184, to display a television program. When media bridge media bridge 130 receive data from email notification module 1010 that a user at device 180, 182, 184 should receive an email notification, media bridge 130 may augment the set of commands comprising portion 1004 such that the set of commands comprising portion 1004 may now, when rendered, display the same part of a television program and in addition, a graphic on the device 180, 182, 184 indicating that a user has an email.

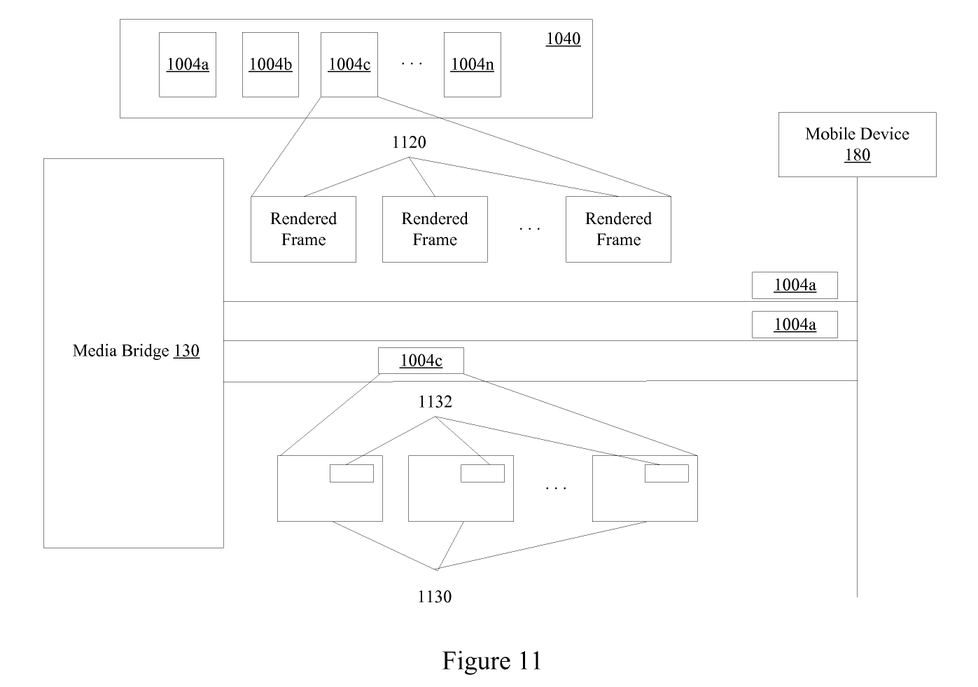

This embodiment of this particular application of the techniques and mechanisms of the present may be depicted more clearly with reference to FIG. 11. Content 1040 may include portions 1004. Suppose now that media bridge 130 is delivering content 1040 to device 180, and further suppose that media bridge 130 has delivered portions 1004a and 1004b to device 180 when media bridge 130 receives data from email notification module 1010 that device 180 should receive a graphic notification that a user has email.

Thus, media bridge 130 may determine that the next portion of content 104 to be delivered to device 180 is portion 1004c. Portion 1004c may include a set of commands such that when portion 1004c is rendered frames 1120 may be displayed along with a corresponding audio track.

To notify a user of device 180 that he has email, then, before delivering portion 1004c of content 1040 to device 180 media bridge 130 may augment the set of commands comprising portion 1004c such that, when rendered, the set of commands now comprising portion 1004c may display frames 1130, which include graphic 1132 informing the user he has email. Portion 1004c of content 1040 may then be delivered to device 180. By augmenting the set of commands comprising portions of content an almost endless variety of notification methodologies may be employed, and an almost endless variety of out-of-band activities or data may be delivered to a user at a given device 180, 182, 184.

Though the embodiments described above utilize embodiments of the present invention in a media bridge designed to convert broadcast media such as television into a variety of formats for delivery over a wireless communication network, those skilled in the art will appreciate that these same techniques and mechanisms may be employed for a myriad number of other uses and applications, such as delivering internet content over a wireline system, or other type of network topology. Additionally, it will be understood that these same techniques and mechanisms, or any subset, can be implemented in a variety of software systems, computer programs, hardware, and any combination thereof, and that embodiments of these techniques and mechanisms may be used to similarly provide a user with notifications regarding an almost limitless set of events, such as voice mail, stock market changes, text messages, among many others.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

1. A method, comprising:
receiving a media stream, wherein the media stream is separated into a plurality of portions;
modifying one of the plurality of portions to include a first procedure;
transmitting the plurality of portions to a mobile device, the mobile device operable to receive the first procedure included in the media stream, decode the media stream, and execute the first procedure, wherein the first procedure is operable to provide notification of an event.

2. The method of claim 1, wherein the first procedure is executed in a first address space associated with a first virtual machine on the mobile device.

3. The method of claim 2, further comprising modifying one of the plurality of portions to include a second procedure.

4. The method of claim 3, wherein the second procedure is executed in a second address space associated with a second virtual machine on the mobile device.

5. The method of claim 4, wherein the first procedure corresponds to a Java procedure.

6. The method of claim 5, wherein the second procedure corresponds to a Python procedure.

7. The method of claim 6, wherein the first address space and the second address space are distinct areas in a memory address space associated with the mobile device.

8. The method of claim 1, wherein the first procedure is a first procedure call.

9. The method of claim 1, wherein modifying one of the plurality of portions comprises augmenting one of the plurality of portions.

10. The method of claim 1, wherein the first procedure is associated with a first command.

11. The method of claim 10, wherein the first commands includes a command identifier, a length indicator, and a data payload.

12. The method of claim 1, wherein the second procedure is associated with a second command.

13. The method of claim 1, wherein the event is receipt of an email or voicemail.

14. The method of claim 1, wherein the event is receipt of a text message.

15. The method of claim 1, wherein the event is proximity detection of another mobile device.

16. A system, comprising:
an interface operable to receive a media stream, wherein the media stream is separated into a plurality of portions;
a processor operable to modify one of the plurality of portions to include a first procedure;
wherein the interface is further operable to transmit the plurality of portions to a mobile device, the mobile device operable to receive the first procedure included in the media stream, decode the media stream, and execute the first procedure, wherein the first procedure is operable to provide notification of an event.

17. The system of claim 16, wherein the first procedure is executed in a first address space associated with a first virtual machine on the mobile device.

18. The system of claim 17, further comprising modifying one of the plurality of portions to include a second procedure.

19. The system of claim 18, wherein the second procedure is executed in a second address space associated with a second virtual machine on the mobile device.

20. An apparatus, comprising:
means for receiving a media stream, wherein the media stream is separated into a plurality of portions;
means for modifying one of the plurality of portions to include a first procedure;
means for transmitting the plurality of portions to a mobile device, the mobile device operable to receive the first procedure included in the media stream, decode the media stream, and execute the first procedure, wherein the first procedure is operable to provide notification of an event.
